(19) United States
(12) Patent Application Publication
(10) Pub. No.: US 2005/0153861 A1
(43) Pub. Date: Jul. 14, 2005

(54) Container

(75) Inventors: Ralf Wiedemann, Ludwigshafen (DE); Roger Kaiser, Ludwigshafen (DE); Marcus Guzmann, Leimen (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofdorp (NL)

(21) Appl. No.: 10/505,565

(22) PCT Filed: Dec. 19, 2002
(86) PCT No.: PCT/GB02/05788

(30) Foreign Application Priority Data
Feb. 26, 2002 (GB) 0204363.6

(51) Int. Cl. C11D 17/00

(52) U.S. Cl. 510/439

(57) ABSTRACT

Packaged detergent composition comprising a container that at least partly disintegrates in an aqueous environment, the detergent composition comprising at least one liquid and at least one solid substantially insoluble in the liquid and preferably having a size sufficient to be retained by a 2.5 mm mesh wherein the at least one solid has a density lower than the density of the liquid

The present invention relates to a packaged detergent composition comprising a container which at least partly disintegrates in an aqueous environment, the detergent composition comprising at least one liquid phase and at least one solid substantially insoluble in the liquid phase and having a size sufficiently large to be retained by a 2.5 mm mesh. The invention is particularly useful in warewashing in automatic dishwashing machines or laundry washing machines.

Containers made of a material that at least partly disintegrate in an aqueous environment, and in particular those made of a water-soluble film material, are known for packaging detergent compositions, including detergent additive compositions. In particular in the case of liquid compositions, such packaged detergents are found to be attractive to consumers because of easier handling and dosing, and avoiding spillage when dropped.

Such containers, in particular so-called sachets, i.e. flexible pouch-like packages, are known from a number of documents of prior art. For example, EP 0 507 404 B1 discloses detergent containing sachets for use in an automatic dishwashing machine, those sachets, however, containing detergent powder material.

It is also known to manufacture water-soluble containers having more than one compartment to enable presence in the same container of compositions having some kind of mutual incompatibility. Laundry additive sachets containing one or more liquid composition and having two or more compartments are known from EP 1 126 070 A1 and WO 01/61099. Other types of detergent material packaged in a water-soluble polymeric material are known from WO 01/29172A1 and WO 01/40432A1.

It has been considered, for different reasons, to provide a water-soluble sachets containing a detergent composition comprising at least one liquid phase and at least one solid of a substantial size. Such a solid may contain ingredients to be protected from the liquid phase, or ingredients which are soluble in the liquid phase, and may, for that reason, be surrounded by a protective coating insoluble in the liquid phase. It may also be intended to incorporate ingredients in such a solid to provide for a sequential release profile of ingredients from the solid, i.e. either delayed release by providing specific coatings or the like, or accelerated release by providing means for disintegration and release of ingredients into the washing liquor. Moreover, such packaged detergent compositions may be particularly attractive to consumers because of their specific aesthetic appearance.

However, there is a specific problem, which may arise in the case of the combination of a viscous liquid with a solid contained therein. When water-soluble packages comprising a viscous liquid compositions and at least one solid is added into water the package dissolves exposing its contents to the aqueous environment. Usually, after dissolution/disintegration of the package, it takes some time for the viscous liquid composition to dissolve/diffuse within the aqueous environment. Actually, it has been observed that, after dissolution/disintegration of the water-soluble package, the liquid can maintain its shape as a consequence of its viscosity for a certain time period.

When the packaged detergent additionally comprises at least one solid contained within and being insoluble in the viscous liquid, the above described delayed dissolution/diffusion of the liquid may hinder the release of the solid into the washing liquor by holding it therein. This is particularly disadvantageous if the solid is intended for fast dissolution in the washing liquor, i.e. for early release of ingredients contained therein to be active in an early stage of the washing procedure. One example of such ingredients may be enzymes, which are temperature-sensitive and should act in the washing liquor at an early stage when the temperature has not been raised to a substantial extent.

Therefore, it is an object of the present invention to provide for an improved packaged detergent of above-described type allowing easy and early release of solid(s) contained in the liquid after dissolution/disintegration of the water-soluble package material in the washing liquor.

The present invention provides, for a solution of this object, for a packed detergent composition of the above-defined type wherein the at least one solid has a density lower then the density of the liquid.

Preferably, the at least one liquid has a dispersion/dissolution time in water at 10° C. of more than 30 s measured under the following test conditions:

The solid, or at least any coating that is used on the solid, is soluble in the water environment into which it is released, but it is insoluble in the liquid of the packaged detergent composition.

The solid may be any size such as a powder, particle, granule, or larger. Larger solid may be prepared by any number of techniques such as compaction, extrusion or agglomeration techniques known to the skilled person. Larger solid is preferred and is ideally sufficiently large that it will be retained by a 2.5 mm mesh.

Method for Measuring Dispersion-Dissolution Time of the Liquid Phase:

A 5 l beaker (diameter: 18 cm) is filled with 4.5, l tap water (15-20° dH). The temperature is maintained at 40° C. A propeller-stirrer with a diameter of 78 mm is immersed into the beaker (immersion depth 53.5 mm).

A sachet made by thermoforming PT75, filled it with 18 ml of the liquid composition to be tested and sealed with PT75 is dropped into the pre-heated water, which is stirred at 150 rpm.

The sachet starts dissolving and the time (in seconds) elapsed until the release of the liquid phase into water starts (Tₛₜₐᵣₜ) is determined either visually if the liquid phase is colored or generates turbidity when being dissolved in water, or alternatively by detecting the increase in conductivity of water.

The sachet is then visually observed and the time when its height is reduced by 80 % is annotated as the final time (in seconds).

The dispersion/dissolution time of the liquid composition is then calculated as:
T_{disp}=T_{final}−Tₛₜₐᵣₜ

It has also been observed that the reduction of the solid's release time when using a floating solid with a density lower then the density of the liquid according to the invention is more pronounced when the liquid phase has a viscosity of at least 100 mPa.s, preferably at least 500 mPa.s, more preferably at least 1.000 mPa.s, most preferably at least 10.000 mPa.s.

Preferably, the container holding the packaged detergent composition of the present invention is a sachet. The material of the container is preferably essentially water-soluble, in particular it preferably comprises polyvinyl alcohol. By use of the term “water-soluble” we also include water-dispersible.

The packaged detergent of the present invention is particularly useful for use in a laundry washing machine, more preferably in an automatic dishwashing machine where mechanical agitation of the washing liquor is less intense.

It has now surprisingly been observed that the above-described hindrance of the release of the solid(s) into the washing liquor can reliably be avoided by adjusting the density of the solid(s) to be less than the density of the liquid in which it is contained. By that means, the solid(s) is (are) floating or easily rising to the outer surface of the viscous liquid composition. Compared to a situation where the solid(s) is (are) completely surrounded by the viscous liquid, it is then much more exposed to the washing liquor and therefore easier to be released thereinto. This effect is surprisingly distinct and has been shown in a specifically designed method for measuring the solid release from a water-soluble sachet according to above-described type. This measurement method is disclosed in more detail in the context of the following example, which is intended for illustration only and not for limiting the invention beyond the scope as defined in the claims.

In all executions under the present invention the packaging may be formed using different techniques known to the expert in the field of forming water-soluble packaging. As non-limiting examples of such techniques one can mention techniques making use of processes moulding the water-soluble raw material of the packaging, especially injection moulding or blow moulding, and also techniques making use of a preformed film of water-soluble material such as thermoforming, vertical form-fill-sealing or horizontal form-fill-sealing.

In the case of techniques making use of preformed film materials, the film may be a single film, or a laminated film as disclosed in GB-A-2,244,258. While a single film may have pinholes, the two or more layers in a laminate are unlikely to have pinholes, which coincide.

The film itself may be produced by any process, for example by extrusion and blowing or by casting. The film may be unoriented, monoaxially oriented or biaxially oriented. If the layers in the film are oriented, they usually have the same orientation, although their planes of orientation may be different if desired.

The layers in a laminate may be the same or different. Thus they may each comprise the same polymer or a different polymer.

Examples of water-soluble polymers which may be used in a single layer film or in one or more layers of a laminate or which may be used for injection moulding or blow moulding are poly(vinyl alcohol) (PVOH), cellulose derivatives such as hydroxypropyl methyl cellulose (HPMC) and gelatine. An example of a preferred PVOH is ethoxylated PVOH. The PVOH may be partially or fully alcoholised or hydrolysed. For example it may be from 40 to 100%, preferably from 70 to 92%, more preferably about 88% or about 92%, alcoholised or hydrolysed. The degree of hydrolysis is known to influence the temperature at which the PVOH starts to dissolve in water. 88% hydrolysis corresponds to a film soluble in cold (i.e. room temperature) water, whereas 92% hydrolysis corresponds to a film soluble in warm water.

The thickness of the film used to produce the container, which may be in the form of a pocket, is preferably 30 to 300 μm, more preferably 40 to 200 μm, especially 60 to 170 μm, and most especially 65 to 155 μm.

In one possible execution using film material the packaging may be formed by, for example, vacuum forming or thermoforming. For example, in a thermoforming process the film may be drawn down or blown down into a mould. Thus, for example, the film is heated to the thermoforming temperature using a thermoforming heater plate assembly, and then drawn down under vacuum or blown down under pressure into the mould. Plug-assisted thermoforming and pre-stretching the film, for example by blowing the film away from the mould before thermoforming, may, if desired, be used. One skilled in the art can choose an appropriate temperature, pressure or vacuum and dwell time to achieve an appropriate pocket. The amount of vacuum or pressure and the thermoforming temperature used depend on the thickness and porosity of the film and on the polymer or mixture of polymers being used. Thermoforming of PVOH films is known and described in, for example, WO 00/55045.

A suitable forming temperature for PVOH or ethoxylated PVOH is, for example, from 90 to 130° C., especially 90 to 120° C. A suitable forming pressure is, for example, 69 to 138kPa (10 to 20 p.s.i.), especially 83 to 117 kPa (12 to 17 p.s.i.). A suitable forming vacuum is 0 to 4 kPa (0 to 40 mbar), especially 0 to 2 kPa (0 to 20 mbar) . A suitable dwell time is, for example, 0.4 to 2.5 seconds, especially 2 to 2.5 seconds.

While desirably conditions chosen within the above ranges, it is possible to use one or more of these parameters outside the above ranges, although it may be necessary to compensate by changing the values of the other two parameters.

When the container comprises more than one compartment each compartment may be formed by any of the above mentioned techniques.

The compartments are then filled with the desired compositions. The compartments may be completely filled or only partially filled. The composition may be a solid. For example, it may be a particulate or granulated solid, or a tablet. It may also be a liquid, which may be thickened or gelled if desired. The liquid composition may be non-aqueous or aqueous, for example comprising less than or more than 5% total or free water. The composition may have more than one phase. For example it may comprise an aqueous composition and a liquid composition which is immiscible with the aqueous composition. It may also comprise a liquid composition and a separate solid composition, for example in the form of a ball, pill or speckles.

The container may contain more than one component; for instance it may contain two components which are incompatible with each other. It may also contain a component, which is incompatible with the part of the container enclosing the other component. For example, the second composition may be incompatible with the part of the container enclosing the first composition.

Alternatively the packaging may be formed of, for example, a moulded composition, especially one produced by injection moulding or blow moulding. The walls of the compartment may, for example, have a thickness of greater than 100 μm, for example greater than 150 μm or greater than 200 μm, 300 μm, 500 μm, 750 μm or 1 mm. Preferably the walls have a thickness of from 200 to 400 μm.

The composition may be a fabric care, surface care or dishwashing composition. Thus, for example, it may be a dishwashing, water softening, laundry or detergent composition, or a rinse aid. Such compositions may be suitable for use in a domestic washing machine. The composition may also be a disinfectant, antibacterial or antiseptic composition, or a refill composition for a trigger-type spray. Such compositions are generally packaged in amounts of from 5 to 100 g, especially from 15 to 40 g. For example, a dishwashing composition may weigh from 15 to 30 g, a water-softening composition may weigh from 15 to 40 g.

The composition, if in liquid form, may be anhydrous or comprise water, for example at least 5 wt %, preferably at least 10 wt%, water based on the weight of the aqueous composition.

In case more than one composition is packaged, the compositions may be the same or different. If they are different, they may, nevertheless, have one or more individual components in common.

In a possible execution a sealing member is placed on top of the first compartment previously filed and sealed thereto.

The sealing member may be produced by, for example, injection moulding or blow moulding. It may also be in the form of a film.

The sealing member may optionally comprise a second composition at the time it is placed on top of the first compartment. This may be held or otherwise adhered on the sealing member. For example it can be in the form of a solid composition such as a ball or pill held on the sealing member by an adhesive or mechanical means. This is especially appropriate when the sealing member has a degree of rigidity, such as when it has been produced by injection moulding. It is also possible for a previously prepared container containing the second composition to be adhered to the sealing member. For example, a sealing member in the form of a film may have a filled compartment containing a composition attached thereto. The second composition or compartment may be held on either side of the sealing member such that it is inside or outside the first compartment.

Generally, however, the second composition is held within a second compartment in the sealing member. This is especially appropriate when the sealing member is flexible, for example in the form of a film.

The sealing member is placed on top of the first compartment and sealed thereto. For example the sealing member in the form of a film may be placed over a filled pocket and across the sealing portion, if present, and the films sealed together at the sealing portion. In general there is only one second compartment or composition in or on the sealing member, but it is possible to have more than one second compartment or composition if desired, for example 2 or 3 second compartments or compositions.

The second compartment may be formed by any technique. for example, be formed by vertical form fill sealing the second composition within a film, such as by the process described in WO 89/12587. It can also be formed by having an appropriate shape for an injection moulding.

However, it is preferred to use a vacuum forming or thermoforming techniques, such as that previously described in relation to the first compartment of the container of the present invention. Thus, for example, a pocket surrounded by a sealing portion is formed in a film, the pocket is filled with the second composition, a film is placed on top of the filled pocket and across the sealing portion and the films are sealed together at the sealing portion. In general, however, the film placed on top of the filled pocket to form the second compartment does not itself comprise a further compartment.

Further details of this thermoforming process are generally the same as those given above in relation to the first compartment of the container of the present invention. All of the above details are incorporated by reference to the second compartment, with the following differences:

The second compartment is often smaller than the first compartment since the film containing the second composition is used to form a lid on the pocket. In general the first compartment and the second compartment (or composition if not held within a compartment) have a volume ratio of from 1:1 to 20:1, preferable 2:1 to 10:1. Generally the second compartment does not extend across the sealing portion.

The thickness of the film comprising the second compartment may also be less than the thickness of the film making up the first compartment of the container of the present invention, because the film is not subjected to as much localised stretching in the thermoforming step. It is also desirable to have a thickness which is less than that of the film used to form the first compartment to ensure a sufficient heat transfer through the film to soften the base web if heat sealing is used.

The thickness of the covering film is generally from 20 to 160 μm, preferably from 40 to 100 μm, such as 40 to 90 μm or 50 to 80 μm.

This film may be a single-layered film but is desirably laminated to reduce the possibility of pinholes allowing leakage through the film. The film may be the same or different as the film forming the first compartment. If two or more films are used to form the film comprising the second compartment, the films may be the same or different. Examples of suitable films are those given for the film forming the first compartment.

The first compartment and the sealing member may be sealed together by any suitable means, for example by means of an adhesive or by heat sealing. Mechanical means is particularly appropriate if both have been prepared by injection moulding. Other methods of sealing include infrared, radio frequency, ultrasonic, laser, solvent, vibration and spin welding. An adhesive such as an aqueous solution of PVOH may also be used. The seal desirably is water-soluble if the containers are water-soluble.

If heat sealing is used, a suitable sealing temperature is, for example, 120 to 195° C., for example 140 to 150° C. A suitable sealing pressure is, for example, from 250 to 600 kPa. Examples of sealing pressures are 276 to 552 kPa (40 to 80 p.s.i.), especially 345 to 483 kPa (50 to 70 p.s.i.) or 400 to 800 kPa (4 to 8 bar), especially 500 to 700 kPa (5 to 7 bar) depending on the heat-sealing machine used. Suitable sealing dwell times are 0.4 to 2.5 seconds.

One skilled in the art can use an appropriate temperature, pressure and dwell time to achieve a seal of the desired integrity. While desirably conditions are chosen within the above ranges, it is possible to use one or more of these parameters outside the above ranges, although it might be necessary to compensate by changing the values of the other two parameters.

In a second embodiment of the invention, the sealing member does not comprise the second composition at the time it is placed on top of the first component. Instead the second composition is added afterwards. Thus, for example, it may be adhered to the sealing member by means of an adhesive. It may also be adhered by mechanical means, particularly when the sealing member has a degree of rigidity, for example when injection moulding has produced it. Another possibility is for the sealing member to contain an indentation, which is filled, either before or after sealing, by a liquid composition, which is allowed to gel in-situ.

If more than one container is formed at the same time from the same sheet, the containers may then be separated from each other, for example by cutting the sealing portions, or flanges. Alternatively, they may be left conjoined and, for example, perforations provided between the individual containers so that they can be easily separated a later stage, for example by a consumer. If the containers are separated, the flanges may be left in place. However, desirably the flanges are partially removed in order to provide an even more attractive appearance. Generally the flanges remaining should be as small as possible for aesthetic purposes while bearing in mind that some flange is required to ensure the two films remain adhered to each other. A flange having a width of 1 mm to 8 mm is desirable, preferably 2 mm to 7 mm, most preferably about 5 mm.

The containers may themselves be packaged in outer containers if desired, for example non-water soluble containers, which are removed, before the water-soluble containers are used.

The containers produced by the process of the present invention, especially when used for a fabric care, surface care or dishwashing composition, may have a maximum dimension of 5 cm, excluding any flanges. For example, a container may have a length of 1 to 5 cm, especially 3.5 to 4.5 cm, a width of 1.5 to 3.5 cm, especially 2 to 3 cm, and a height of 1 to 3 cm, especially 1.25 to 2.00 cm.

The ingredients of the compositions depend on the use of such compositions. Thus, for example, the composition may contain surface-active agents such as a nonionic, anionic, cationic, amphoteric or zwitterionic surface-active agents or mixtures thereof.

Examples of non-ionic surfactants useful in the compositions of the present invention are preferably bleach-stable surfactants. Non-ionic surfactants generally are well known, being described in more detail in Kirk Othmer's Encyclopedia of Chemical Technology, 3rd Ed., Vol. 22, pp. 360-379, “Surfactants and Detersive Systems”, incorporated by reference herein.

One possible class of nonionics are ethoxylated non-ionic surfactants prepared by the reaction of a monohydroxy alkanol or alkylphenol with 6 to 20 carbon atoms with at least 1 mole, preferably at least 3 moles, more preferably at least 12 moles particularly preferred at least 16 moles, and still more preferred at least 20 moles of ethylene oxide per mole of alcohol or alkylphenol.

Particularly preferred non-ionic surfactants are the non-ionic from a linear chain fatty alcohol with 16-20 carbon atoms and at least 12 moles particularly preferred at least 16 and still more preferred at least 20 moles of ethylene oxide per mole of alcohol.

According to one preferred embodiment of the invention, the non-ionic surfactants additionally comprise propylene oxide units in the molecule. Preferably this PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of non-ionic surfactants includes reverse block copolymers of polyoxyethylene and polyoxypropylene and block copolymers of polyoxyethylene and polyoxypropylene initiated with trimethylolpropane.

Another preferred moderate-to-high cloud point nonionic surfactant can be described by the formula:
R¹O[CH₂CH(CH₃)O]_{X}[CH₂CH₂O]_{Y}[CH₂CH(OH)R²]
where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:
R¹O[CH₂CH(R³)O]_{X}[CH₂]ₖCH(OH) [CH₂]ⱼOR²
w[W]here R¹ and R2 represent linear or branched chain, saturated or unsaturated, alyphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group , x is a value between 1 and 30 and, k and j are values between 1 and 12, preferably between 1 and 5. When the value of x is ≧2 each R³ in the formula above can be different. R¹ and R² are preferably linear or branched chain, saturated or unsaturated, alyphatic or aromatic hydrocarbon groups with 6-22 carbon atoms, where group with 8 to 18 carbon atoms are particularly preferred. For the group R³ H, methyl or ethyl are particularly preferred. Particularly preferred values for x are comprised between 1 and 20, preferably between 6 and 15.

As described above, in case x≧2, each R³ in the formula can be different. For instance, when x=3, the group R³ could be chosen to build ethylene oxide (R³=H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:
R¹O[CH₂CH (R³)O]_{X}CH₂CH(OH)CH₂OR²
Further nonionic surfactants are, for example, C₁₀-C₁₈ alkyl polyglycosides, such s C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glucamides and ethylene oxide-propylene oxide block polymers of the Pluronic type.

The use of mixtures of different nonionic surfactants is particularly preferred in the context of the present invention for instances mixtures of alkoxylated alcohols and hydroxy group containing alkoxylated alcohols.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols.

Examples of primary alkyl sulfate surfactants are those of formula:
ROSO₃⁻M⁺
wherein R is a linear C₈-C₂₀ hydrocarbyl group and M is a water-solubilising cation. Preferably R is C₁₀-C₁₆ alkyl, for example C₁₂-C₁₄, and M is alkali metal such as lithium, sodium or potassium.

Examples of secondary alkyl sulfate surfactants are those which have the sulfate moiety on a “backbone” of the molecule, for example those of formula:
CH₂(CH₂)ₙ(CHOSO₃⁻M⁺) (CH₂)ₘCH₃
wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:
CH₂ (CH₂)ₓ(CHOSO₃⁻M⁺) CH₃ and
CH₃ (CH₂)ₓ(CHOSO₃⁻M⁺) CH₂CH₃
for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:
RO(C₂H₄O)ₙSO₃⁻M⁺
wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates.

The alkyl sulfates and alkyl ether sulfates will generally be used in the form of mixtures comprising varying alkyl chain lengths and, if present, varying degrees of alkoxylation.

Other anionic surfactants, which may be employed, are salts of fatty acids, for example C₈-C₁₈ fatty acids, especially the sodium or potassium salts, and alkyl, for example C₈-C₁₈, benzene sulfonates.

Examples of cationic surfactants are those of the quaternary ammonium type.

The total content of surfactants in the composition is desirably 60 to 95 wt %, especially 75 to 90 wt %. Desirably an anionic surfactant is present in an amount of 50 to 75 wt %, the nonionic surfactant is present in an amount of 5 to 20 wt %, and/or the cationic surfactant is present in an amount of from 0 to 20 wt %. The amounts are based on the total solids content of the composition, i.e. excluding any solvent, which may be present.

The composition, particularly when used as laundry washing or dishwashing composition, may also comprise enzymes, such as protease, lipase, amylase, cellulase and peroxidase enzymes. Such enzymes are commercially available and sold, for example, under the registered trademarks Esperase, Alcalase and Savinase by Novo Industries A/S and Maxatase by International Biosynthetics, Inc. Desirably the enzymes are present in the composition in an amount of from 0.5 to 3 wt %, especially 1 to 2 wt %.

The composition may, if desired, comprise a thickening agent or gelling agent. Suitable thickeners are polyacrylate polymers such as those sold under the trademark CARBOPOL, or the trademark ACUSOL by Rohm and Haas Company. Other suitable thickeners are xanthan gums. The thickener, if present, is generally present in an amount of from 0.2 to 4 wt %, especially 0.5 to 2 wt %.

Dishwasher compositions usually comprise a detergency builder. Suitable builders are alkali metal or ammonium phosphates, polyphosphates, phosphonates, polyphosphonates, carbonates, bicarbonates, borates, polyhydroxysulfonates, polyacetates, carboxylates such as citrates, and polycarboxylates. The builder is desirably present in an amount of up to 90 wt %, preferably 15 to 90 wt %, more preferable 15 to 75 wt %, relative to the total weight of the composition. Further details of suitable components are given in, for example, EP-A-694,059, EP-A-518,720 and WO 99/06522.

The compositions can also optionally comprise one or more additional ingredients. These include conventional detergent composition components such as further surfactants, bleaches, bleach enhancing agents, builders, suds boosters or suds suppressors, anti-tarnish and anti-corrosion agents, organic solvents, co-solvents, phase stabilisers, emulsifying agents, preservatives, soil suspending agents, soil release agents, germicides, pH adjusting agents or buffers, non-builder alkalinity sources, chelating agents, clays such as smectite clays, enzyme stabilisers, anti-limescale agents, colorants, dyes, hydrotropes, dye transfer inhibiting agents, brighteners, and perfumes. If used, such optional ingredients will generally constitute no more than 10 wt %, for example from 1 to 6 wt %, the total weight of the compositions.

The builders counteract the effects of calcium, or other ion, water hardness encountered during laundering or bleaching use of the compositions herein. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-C₂₂ fatty acids and citric acid. Other examples are organic phosphonate type sequestering agents such as those sold by Monsanto under the trademark Dequest and alkylhydroxy phosphonates. Citrate salts and C₁₂-C₁₈ fatty acid soaps are preferred.

Other suitable builders are polymers and copolymers known to have builder properties. For example, such materials include appropriate polyacrylic acid, polymaleic acid, and polyacrylic/polymaleic and copolymers and their salts, such as those sold by BASF under the trademark Sokalan.

The builders generally constitute from 0 to 3 wt %, more preferably from 0.1 to 1 wt %, by weight of the compositions.

Compositions, which comprise an enzyme, may optionally contain materials, which maintain the stability of the enzyme. Such enzyme stabilisers include, for example, polyols such as propylene glycol, boric acid and borax. Combinations of these enzyme stabilisers may also be employed. If utilised, the enzyme stabilisers generally constitute from 0.1 to 1 wt % of the compositions.

The compositions may optionally comprise materials, which serve as phase stabilisers and/or co-solvents. Examples are C₁-C₃ alcohols such as methanol, ethanol and propanol. C₁-C₃ alkanolamines such as mono-, di- and triethanolamines can also be used, by themselves or in combination with the alcohols. The phase stabilisers and/or co-solvents can, for example, constitute 0 to 1 wt %, preferably 0.1 to 0.5 wt %, of the composition.

The compositions may optionally comprise components, which adjust or maintain the pH of the compositions at optimum levels. The pH may be from, for example, 1 to 13, such as 8 to 11 depending on the nature of the composition. For example a dishwashing composition desirably has a pH of 8 to 11, a laundry composition desirable has a pH of 7 to 9, and a water-softening composition desirably has a pH of 7 to 9. Examples of pH adjusting agents are NaOH and citric acid.

The primary composition and the secondary composition may be appropriately chosen depending on the desired use of the article.

If the article is for use in laundry washing, the first composition may comprise, for example, a detergent, and the second composition may comprise a bleach, stain remover, water-softener, enzyme or fabric conditioner. The article may be adapted to release the compositions at different times during the laundry wash. For example, a bleach or fabric conditioner is generally released at the end of a wash, and a water softener is generally released at the start of a wash. An enzyme may be released at the start or the end of a wash.

If the article is for use as a fabric conditioner, the first composition may comprise a fabric conditioner and the second composition may comprise an enzyme, which is released before or after the fabric conditioner in a rinse cycle.

If the article is for use in dish washing the first composition may comprise a detergent and the second composition may comprise a water-softener, salt, enzyme, rinse aid, bleach or bleach activator. The article may be adapted to release the compositions at different times during the laundry wash. For example, a rinse aid, bleach or bleach activator is generally released at the end of a wash, and a water softener, salt or enzyme is generally released at the start of a wash.

### EXAMPLE

26.5 g detergent composition, usual and suitable for use in an automatic dishwashing machine, as shown in Table I, and being a liquid composition of a viscosity of about . . . mPas, is filled into a package made by thermoforming a polyvinyl alcohol film with a thickness of 75 μm.

TABLE I

| | % wt. |
|---|---|
| Potassium | 30.00 |
| tripolyphosphate | |
| Sodium citrate | 30.00 |
| Enzymes | 0.97 |
| Polyacrylate | 0.25 |
| Phosphoric acid | 0.10 |
| Water | 38.680 |
| Density | 1.5 g/ml |

A mixture of 55 wt.-% of molten polyethylene glycol with an average molecular weight of 35.000 (PEG 35.000) and 45 wt.-% of a non-ionic surfactant (Plurafac LF 403®) is prepared and used to coat core particles of different sizes and weight to obtain solid(s) with a constant overall diameter of 11 mm. By this method, solid(s) with the same composition on its surface and the same size were obtained, however allowing to adjust the densities by variation of the density of the core particles.

The solid(s), as obtained, were dropped into the filled thermoformed package prior to closing it by heat sealing.

Method for Measuring Solid Release from Water-Soluble Sachet

A 5 l beaker (diameter: 18 cm) is filled with 4.5, l tap water (15-20° dH). The temperature is maintained at 40° C. A propeller-stirrer with a diameter of 78 mm is immersed into the beaker (immersion depth 53.5 mm).

A sachet is dropped into the pre-heated water which is stirred at 150 rpm.

The sachet is visually observed and the time elapsed until at least 50% of the solid is exposed to the solution is annotated as the release time.

Three different products, produced as described herein-above, are tested according to that method, and the results are shown in Table II.

TABLE II

| Density of | Δ | |
|---|---|---|
| solid | density | Release time |
| (g/ml) | (g/ml) | (min) |
| 1.1 | −0.4 | 2.0 |
| 1.9 | +0.4 | 4.5 |
| 2.5 | +1.0 | 4.5 |

From the results, it is obvious, that the release time of the solid into the aqueous environment is much better when the density of the solid is lower than the density of the liquid composition in which the solid is contained, thus allowing floating or easy rising of the solid to the surface of the liquid viscous composition.

The features disclosed in the foregoing description, in the claims and/or drawings in the accompanying drawings may, both separately and in any combination thereof, be material for realizing the invention in diverse forms thereof.

1. A packaged detergent composition comprising a container that at least partly disintegrates in an aqueous environment, the detergent composition comprising at least one liquid and at least one solid substantially insoluble in the liquid characterized in that the at least one solid has a density lower than the density of the liquid.

2. A packaged detergent composition according to claim 1, wherein the at least one solid has a size sufficient to be retained by a 2.5 mm mesh.

3. A packaged detergent composition according to claim 1, wherein the at least one liquid has a dispersion/dissolution time as measured by the dispersion/dissolution time test of more than 30 s.

4. A packaged detergent composition according to claim 1, wherein the at least one liquid has a viscosity of at least 100 mPa.s.

5. A packaged detergent composition according to claim 1 any one of the preceding claims, wherein the container is a sachet.

6. A packaged detergent composition according to claim 1 any one of the preceding claims, wherein the material of the container is essentially water-soluble.

7. A packaged detergent composition according to claim 5, wherein the water-soluble material comprises polyvinyl alcohol.

8. Use of the packaged detergent composition according to claim 1 in an automatic dishwashing machine.

9. Use of the packaged detergent composition according to claim 1 in a laundry washing machine.

10. A packaged detergent composition according to claim 2 wherein the at least one liquid has a dispersion/dissolution time as measured by the dispersion/dissolution time test of more than 30 s.

11. A packaged detergent composition according to claim 10 wherein the at least one liquid has a viscosity of at least 100 mPa.s.

12. A packaged detergent composition according claim 10 wherein the container is a sachet.

13. A packaged detergent composition according to claim 10 wherein the material of the container is essentially water-soluble.

14. A packaged detergent composition according to claim 13, wherein the water-soluble material comprises polyvinyl alcohol.
